(19) United States
(12) Patent Application Publication
(10) Pub. No.: US 2008/0017826 A1
(43) Pub. Date: Jan. 24, 2008

(54) BINDER AND PARTICULATE CONTAINING COMPOSITIONS

(76) Inventor: Ian PEARSE, Yarra Glen (AU)

Correspondence Address: MERCHANT & GOULD PC, P.O. BOX 2903, MINNEAPOLIS, MN, 55402-0903, US

(21) Appl. No.: 11/756,162

(22) Filed: May 31, 2007

(30) Foreign Application Priority Data
Jul. 21, 2006 (AU) 2006903960

(51) Int. Cl. C09K 3/00

(52) U.S. Cl. 252/1; 252/182.12; 252/182.29; 252/182.3

(57) ABSTRACT

A polymeric blend of a binder composition and a particulate containing composition that includes the binder composition may be used in applications to replace conventional sand and turf surfaces. Preferably the particulate containing composition is suitable for forming a surface on which equestrian activities such as horse training and racing can be carried out. The binder composition includes oil and one or more additives that provides the oil with a suitable viscosity over a temperature range. The oil, preferably a non-aromatic containing oil, is suitable for mixing with and increasing the elasticity and/or viscosity of an emulsion including particulate material, such as but by not means limited to sand. The polymeric blend includes either one or a combination of ethylene propylene and styrene butadiene either as homopolymers or copolymers.

### FIELD AND BACKGROUND OF THE PRESENT INVENTION

The present invention relates to a polymeric blend, a binder composition and a particulate containing composition that includes the binder composition. The present invention may be used in a broad range of applications including applications in which the particulate composition replaces conventional sand and turf surfaces.

Sand and turf surfaces are common in a range of sporting activities including: horse tracks either for training or racing; equestrian arenas for dressage; and dog tracks. However, both sand and turf surfaces require large amounts of watering and leveling and in the case of turf, mowing and fertilizing. Synthetic surfaces in the form of especially prepared particulate compositions have been used to replace traditional sand and turf surfaces for 10 or more years and it is widely accepted that surfaces made therefrom do not require the same degree of maintenance and in particular watering. In addition, there is strong evidence to suggest that the incidence of injuries to race horses is less on synthetic surfaces than on traditional surfaces.

U.S. Pat. No. 5,961,389 describes a particulate composition suitable for race tracks. The composition comprises a mixture of sand, polyolefin fibres, polyolefin particles, tire fibres and a hydrocarbon wax. The wax is characterized as a paraffin wax which is derived from petroleum by-products. A coating of wax is applied to the sand and fibre by melting the wax over a range of 130 to 155° F.

In our experience, particulate compositions containing wax are suited to applications over a limited temperature range. In particular, when the ground temperature falls below the designated temperature range of the wax, the surface will harden causing increased jarring and in the case when the ground temperature exceeds the designated temperature range, the ground will soften and provide insufficient support. Another difficulty with wax containing compositions is that to our knowledge is it difficult to include a pigment in the composition and thereby provide a lasting colour effect. The colour and appearance of the composition is important aesthetically and for television purposes.

It is an object of the present invention to provide an alternative particulate composition and a polymeric or binding composition that may be included in the particulate composition.

### SUMMARY OF THE PRESENT INVENTION

According to the present invention there is provided a binder composition suitable for combining with a particulate material, the composition comprising oil and one or more additives that provides the oil with a suitable viscosity over a temperature range.

According to the present invention there is also provided a particulate containing composition suitable for forming a surface on which equestrian activities including horses training and racing can be carried out, the composition including: i) a granular material; and ii) a binder composition comprising oil and one or more additives that provides the binder composition with a suitable viscosity over a temperature range such that when mixed with the granular material a surface made from the composition can provide support for equestrian activities. The viscosity of the binder composition has a significant impact on the hardness of the particulate over a temperature range and in our experience determines whether the particulate containing composition is suitable for use on a horse track.

Preferably, the viscosity is greater than 10,000 mPas over a temperature range from 40° C. to 60° C.

Even more preferably, the viscosity is greater than 20,000 or 30,000 or 40,000; 50,000; 60,000; 70,000; 80,000 or 90,000 mPas over a temperature range from 40° C. to 60° C., and suitably the viscosity is greater than 100,000 over that temperature range from 40° C. to 60° C.

Preferably, the viscosity is at least 10,000 mPas over a temperature ranging from 20 to 40° C., and suitably ranging from 100,000 to 700,000 mPas over the temperature range.

Preferably, the viscosity is at least 100,000 mPas over a temperature ranging from −10 to 40° C., and suitably ranging from 100,000 to 700,000 mPas over the temperature range.

Preferably, the viscosity ranges from 200,000 to 600,000 mPas over a temperature range from −10 to 40° C.

Preferably, the viscosity of the composition is at least 100,000 mPas at 30° C., and at least 300,000 mPas at 10° C.

Preferably, the viscosity of the composition is less than 700,000 mPas at −10° C.

According to the present invention there is provided a polymeric blend comprising either one or a combination of ethylene propylene and styrene butadiene either as homopolymers or copolymers.

According to the present invention there is also provided a binder composition that comprises the polymeric blend and oil, preferably a non-aromatic containing oil, wherein the binder composition is suitable for mixing with and increase the elasticity and/or viscosity of an emulsion including particulate material, such as but by not means limited to sand.

According to the present invention there is also provided a particulate composition suitable for forming a surface on which equestrian activities including horses training and racing can be carried out, the composition including: i) a granular material, preferably in the form of sand; and ii) the polymeric blend described above which includes either one or a combination of ethylene propylene and styrene butadiene. Preferably, the polymeric blend is mixed with a non-aromatic containing oil so as to form a binder composition amongst which granular material can be disburse to form an emulsion of solid material.

According to the present invention there is also provided a method for making a track suitable horse racing or training, the method including the steps of:
a) mixing the binder composition with a particulate or granular material at an amount ranging from 1 to 15%;
b) laying the mixture formed by step a) at a thickness greater than 100 mm; and
c) incorporating either one or a combination of fibre, or rubberised or elasticised particles into the mixture formed by step b).

Preferably, the binder composition is added at an amount up to 10% and suitably ranging from 3 to 8% of the weight of the particulate or granular material.

Preferably step a) is carried out when the particulate or granular material is at a temperature in the range of 120 to 140° C.

Preferably, the particulate or granular material is sand having a size ranging from 0.02 to 1.5 mm.

Preferably, the method involves evaporating excess water from the sand before carrying out step a).

Preferably, the step b) involves laying the mixture at a thickness in the range of 100 to 150 mm.

Preferably, step c) involves distributing fibre and rubberised particles over the mixture laid in step b) at an amount up to 10 kg per square metre or up to 12 or 13% by volume.

Preferably, step c) involves harrowing the fibre and rubberised particles into the mixture laid in step b).

The method of the present invention may also include any one or a combination of the feature of the binder composition or particulate containing composition described above.

According to the present invention there is also provided a horse training or racing track, wherein the surface of the track comprises the particulate composition comprising any one or a combination of the features described above.

### DETAILED DESCRIPTION

Details of the binder composition according to an embodiment of the present invention and the particulate composition according to an embodiment of the present invention that contains the binder composition will now be described in further detail.

Binder Composition

Although it is possible that the additive(s) may be any low molecular weight material, preferably the additive(s) includes a co-polymer of ethylene and propylene (EPM) groups either with or with cross-linking or grafting.

According to one embodiment, preferably the additive(s) include a co-polymer of ethylene propylene diene (EPDM) groups.

Preferably the additive comprises a blend of polymeric materials that includes i) a low molecular weight material providing a desired viscosity and ii) a plasticizing agent.

Preferably the plasticizing agent is an aromatic plasticizing agent, suitably have a polymer backbone based on alkylbenzene groups. Alkylbenzene groups decreases the freezing point or the point at which the binder composition effectively becomes a solid. Examples include bi- and trialkylated aromatics.

Preferably, the polymeric blend includes silica. Silica is capable of absorbing the liquid content of the other components of the polymeric blend, and thereby enables the blend to be supplied and handled in a solid form, preferably a powder form prior to mixing with oil.

Preferably, the polymeric blend includes a petroleum based resin that improves adhesion to fibres and/or granular material.

Preferably, the polymeric blend includes a block polymer containing styrene-butadiene groups for improving the longevity of the colour added to the composition. Suitably, the block polymer is a styrene-butadiene-styrene block polymer (SBS) group or a styrene-ethylene-butadiene-styrene block polymer (SEBS) group.

According to a preferred embodiment, preferably the polymeric blend of the binder composition has the following make up:

TABLE 1

| COMPONENT | CONTENT (wt %) |
|---|---|
| Polyalkylbenzene | 15 to 20 |
| Silica | 15.5 to 20.5 |
| Ethylene propylene co-polymer (EPM) | 21.0 to 30 |
| Petroleum resin | 20 to 30 |
| Styrene butadiene block polymer (SBS) | 11.5 to 15.5 |

The binder composition is formed by mixing the polymeric blend containing one or more additives with oil. Although it is possible that the oil mixed with the polymeric blend may be a man made synthetic oil, preferably the oil is derived from a crude oil. The oil may be based on, or contain predominantly either aromatic, or non-aromatic hydrocarbons. Examples of aromatic based oils include oils sold under the trade name Renoil 6123, 8125, 8350, 2850 and 350 by Renkert Oil. An example of oil based on non-aromatics is an oil containing either one or a blend of paraffinic and naphthenic hydrocarbons such as Pronap™ oil which is commercially available oil from Caltex. In the situation where the oil is a non-aromatic containing oil, preferably the oil consists entirely of naphthenic hydrocarbons.

The oil may also be a rubber swelling oil. In the situation where the oil is a rubber swelling oil, the proportion of the polyalklbenzene contained in the polymeric blend may be substantially less than that set out in Table 1 above.

It is also preferred that the particulate composition includes a pigment.

Although the pigment may provide any desired colour, suitably the pigment is a green pigment. Set out below is a list of pigments that are commercially available from Cathay Pigments Ltd. which we have found to be particularly well adapted for mixing with sand, fibre and the binder composition.

Phthalocyanine Green: Pigment Green 7, Colour Index 74260

Phthalocyanine Green: Pigment Green 36, Colour Index 74265

Chromium Oxide Green: Pigment Green 17, Colour Index 77288

Cobalt Green: Pigment Green 26, Colour Index 77344

Mixed Metal Oxide Green: Pigment Green 50, Colour Index 77377

Iron Oxide Green: Pigment Green 605, No Colour Index

The amount of pigment used in the composition is ultimately determined by the shade of colouring required.

Particulate Containing Composition

The particulate containing composition includes: i) the binder composition including any one or a combination of the features thereof described above; and ii) a granular or particulate material.

Although the granular material may be any form and be of any size, preferably the granular material is less than 8.0 mm in size. It is even more preferred that the material is in the size range of 0.05 to 5.0 mm.

Preferably, the amount of binder composition combined with the granular material is in the range of approximately 1 to 15% of the weight of the granular material. Even more preferably, the amount of binder composition combined with the granular material is in the range of approximately 3 to 10% of the weight of the granular material and suitably, in the range of 4 to 6% of the weight of the granular material.

Preferably the granular material comprises sand.

The sand may be any common type of sand and is preferably a silica based sand. Although any particle size of the sand may vary widely and, may for example, vary from 0.05 mm to 5 mm in diameter. Preferably the sand varies from 0.075 to 5.0 mm.

A preferred size distribution of the sand is set out in the following table.

TABLE 2

| | | Size distribution |
|---|---|---|
| Particle size (mm) | | based on weight |
| Fine gravel | >2.00 | <1% |
| Very course sand | >1.0 to 2.0 | <3% |
| Course sand | >0.5 to 1.0 | 13% |
| Medium sand | >0.25 to 0.5 | 49% |
| Fine sand | >0.015 to 0.25 | 34% |
| Very fine sand | >0.05 to 0.15 | 4% |
| Silt and clay | <0.05 | <1% |

Preferably the particulate composition also includes fibre for reinforcing and stabilizing the granular material.

Although it is possible for the fibre to be any geotextile, namely a woven or non-woven fabric, it is preferred that the fibre be in the form of discrete fibres that are randomly distributed in the composition.

The fibre may be any suitable fibre type including polyolefins such as polyethylene, polypropylene, polyester and polyamide. The fibres may be any length ranging from 2 mm to 50 mm. The fibres may be straight or curled.

Preferably, the fibres range from 0.2 to 20 mm in diameter or cross section and suitably, range from 0.5 to 1.5 mm in diameter or cross section.

We have found that a good source of fibre suitable for combining with sand is recycled automobile tyres. The fibre is embedded in the rubber of the tyre and can to a large extent, but by no means completely, separated from the rubber of the tyres.

Normally, fibre from recycled automobile tyres comprises a blend of rayon and polyester, and preferably range in length from 10 mm to 25 mm.

Preferably, the particulate containing composition also includes rubberised or elasticised particles.

One of the benefits of using rubberized particulates is that it further reduces the likelihood of injury to animals such as horses training and racing on track constructed of the material. Moreover, it is widely accepted that horse training and racing tracks made using material such as particulate material of the present can reduce the likelihood of injury by over 50%.

In the situation where the particulate containing composition contains fibres obtained from automobile tyres, it is preferred that the rubberised particles be obtained from automobile tyres. The fibre may to some extent be embedded in the rubber and be handled as single material and will herein after be collectively referred to a cushioning agent.

When the fibre and rubberized particles are both obtained from recycled tyres in the form the said cushioning agent, it is preferred that the fibre be 99 to 90% by weight of cushioning agent. For example, a 60 kg sample of cushioning agent may contain from 59.4 to 54.0 kg of fibre and from 0.6 to 6.0 kg rubberised particles. However, it will be appreciated that the ratio of rubberized particles to fibre obtained from recycled automobile material will ultimately depend on the supplier or manufacture of the material.

In the situation where the particulate composition includes sand, and cushioning agent comprising fibre and rubberized particles obtained from recycled automobile tyres, preferably the fibre and rubberized particles is provided at an amount ranging from 6 to 10% by weight of the sand. As mentioned above the binding composition may be provided at an amount ranging from 4 to 6% of the weight of the sand, and in this situation, for a 1 000 kg sample of sand, the particulate composition preferably includes from 40 to 60 kg of the binder composition and from 60 to 100 kg of cushioning agent.

It is also possible that the fibre and rubber components may be obtained from separate sources and separately added to the granular composition. In this situation, preferably the composition includes up to 9% of fibre by weight of the granular material, and suitably in the range of 1 to 4% by weight of the granular material. The composition may also include up to 10% of rubberized particles by weight of the sand, and suitably in the range of 1 to 6% by weight of the sand.

Another benefit of the particulate composition of the present invention over traditional grass of sand surfaces is that it may not require the same degree of watering or irrigation. For example, the rate of penetration of water through the particulate composition can be controlled or manipulated to suit both dry and wet climates. The rate of penetration of water through the particulate composition is influenced by a number of factors including the degree of the compaction and porosity of the composition. The amount of rubberized material in the composition in part influences the degree of porosity of the composition and, in turn, the rate of penetration of water in the composition. In the situation where a cushioning agent in the form of fibre and rubberized particles is obtained from recycled automobile tyres and the amount of the cushioning agent and binder compositions are both approximately 4% relative to the weight of the sand, the rate of penetration of water under gravity is approximately 65 inches/hour. In contrast, the penetration rate of the water through the sand including approximately 4% binder composition without cushioning agent and having being subject to a similar compaction is approximately 52 inches/hour. In other words, increasing the amount of cushioning agent in the particulate composition increases the penetration rate of water in the composition.

### EXAMPLE

A preferred embodiment of the present invention will now be described with reference to the following example.

Binder Composition

The binder composition according to the preferred embodiment of the present invention comprises oil and one or more additives that provide the oil with a suitable viscosity over a temperature range.

The binder composition is an admixture of an aromatic oil such as Renoil 6123™ or a naphthenic based oil such as Caltex's Pronap 101™ with additives in the form of a blend polymeric materials. When the oil is an aromatic oil, any RA1 oil can be used. The ratio of the oil to polymeric blend on a weight basis may be in the ranges of 99-75 to 1-25, preferably 95-80 to 5-20 and suitably approximately 85 to 15 on weight basis.

The polymeric blend is a specially formulated composition manufactured and supplied by Kettlitz-Chemie GmbH & Co. KG in accordance with our requirements and specifications. The composition of the polymeric blend according to the preferred embodiment comprises the following breakdown.

TABLE 3

| Supplier | Trade Name | Description | Proportion |
|---|---|---|---|
| Kettlitz | Mediaplast | Alkyl Benzene | 17.5% |
| | PM | | |
| Rhodia | Tixosil 38 AB | Silica | 18.0% |
| Lanxess | EPM (Buna) | Ethylene propylene | 24.0% |
| | | co-polymer | |
| Hikotack | Harz | Petroleum Resin | 27.5% |
| Polimeri | SBS | Styrene butadiene block | 13.0% |
| Europa | | polymer | |

EPM co-polymer essentially provides a medium having appropriate viscosity and tackiness over a suitable temperature range and SBS provide a medium with appropriate elasticity and an ability to bond to a pigment of desired colour such as Phtalocyanine Green™ which is available from Cathay Pigments Ltd.

Polyalkylbenzene decreases the freezing point of the polymeric blend when combined with oil and the petroleum based resin provides adhesion properties that enables the binding composition formed from the polymeric blend to adhere to sand and fibre. In the situation where a rubber swelling oil is used, the amount of the polyalkybenzene may be reduced in Table 3 above.

The silica component acts as an absorbent so that the binding composition can be solidified and transported in a solid phase.

In addition a pigment, preferably Phtalocyanine Green™ which is available from Cathay Pigments Ltd is also added to the mixture of oil and polymeric blend and agitated. The amount of pigment added is ultimately dependant on the shade and colour required. It is also possible that a suitable pigment may be included in final product by inclusion in the polymer blend rather than inclusion in the pigment.

The formulation of the polymeric blend and, therefore, the binder composition has been devised to satisfy selected performance criteria. Two criteria are elasticity and viscosity of the binder composition over temperatures ranges that suit horse training and racing tracks. Indeed, training and racing tracks are often subject to a temperature range of −10 to 60° C. One of the difficulties of particulate compositions used in the past that are based on wax, rather oil, is that the wax based particulate compositions soften at temperatures ranging from 30 to 40° C. and, as a result, do not provide adequate stability and support for a horse training or racing track. On the other hand, in our experience tracks manufactured from wax based particulate compositions also have the disadvantage of hardening significantly at temperatures below 5° C. Set out below is a table providing composition information of three polymeric blends and the viscosity of three binder compositions comprising an admixture of the polymeric blends and Pronap 101™ by Caltex. The ratio of oil to polymeric blend is approximately 85 to 15 on a weight basis. As can be seen, the viscosity of the binder composition is at least 55,000 mPas at a temperature ranging from 40 to 60° C.

TABLE 4

| Supplier | Trade Name | Description | Sample A | Sample B | Sample C |
|---|---|---|---|---|---|
| Kettlitz | Mediaplast | Alkyl Benzene | 17.5 | 17.5 | 17.5 |
| | PM | | | | |
| Rhodia | Tixosil 38 AB | Silica | 18.0 | 18.0 | 18.0 |
| Lanxess | EPM (Buna) | Ethylene | 27.0 | 27.0 | 0.0 |
| | | propylene co- | | | |
| | | polymer | | | |
| Kumho | KEP 570 F | Ethylene | 0.0 | 0.0 | 27.0 |
| Polychem | EPMD | propylene Diene | | | |
| Hikotack | Harz | Petroleum Resin | 24.5 | 21.5 | 21.5 |
| Polimeri | SBS | Styrene butadiene | 13.0 | 16.0 | 16.0 |
| Europa | | block polymer | | | |

Particulate Containing Composition

The particulate containing composition includes: i) the binder composition described above; ii) a granular or particulate material in the form of sand; and iii) cushioning agent in the form of fibre and rubber particles obtained from recycles automobile tyres.

In order to reduce transportation costs, the particulate composition suitable for use as the surface of horse training and racing tracks is manufactured locally of the track being installed. Initially, sand from a local source is sieved so as to have a particle size ranging from 0.02 to 1.5 mm. The sand is then heated to a temperature in the range of 150 to 170° C., and preferably 160° C. using asphalt plant equipment so as to evaporate excess water. When the sand cools to a temperature in the range of 120 to 140° C., and preferably 130° C., the binder composition is added to the sand at an amount ranging from 3 to 10%, and preferably 4%, ie 40 kg of binding composition to 1000 kg of sand.

The sand and binder composition is then laid at a thickness ranging from 100 to 150 mm and finally, the cushioning agent, is evenly distributed over the track at an amount up to 10 kg per square meter or at amount approximately equal to 6 to 10% by weight of the sand. The cushioning agent is then harrowed into the sand and binder composition using suitable tractor equipment.

Those skilled in the art of the present invention will appreciate that many modification and variations may be made to the preferred embodiments without departing from the spirit and scope of the present invention.

1. A particulate containing composition suitable for forming a surface on which equestrian activities including horses training and racing can be carried out, the composition including: i) a granular material; and ii) a binder composition comprising oil and one or more additives that provides the binder composition with a suitable viscosity over a temperature range such that when mixed with the granular material a surface made from the composition can provide support for equestrian activities.

2. The composition according to claim 1, wherein the viscosity is greater than 10,000 mPas over a temperature range from 40° C. to 60° C.

3. The composition according to claim 1, wherein the viscosity is greater than 15 50,000 mPas over a temperature range from 40° C. to 60° C.

4. The composition according to claim 1, wherein the viscosity is greater than 100,000 over that temperature range from 40° C. to 60° C.

5. The composition according to claim 1, wherein the viscosity is at least 100,000 mPas over a temperature ranging from 20 to 40° C.

6. The composition according to claim 1, wherein the viscosity is at least 100,000 mPas over a temperature ranging from −10 to 40° C.

7. The composition according to claim 1, wherein the additive includes a co-polymer of ethylene and propylene (EPM) groups.

8. The composition according to claim 1, wherein the additive includes a co-polymer of ethylene propylene diene groups (EPDM).

9. The composition according to claim 1, wherein the additive includes an aromatic plasticizing agent.

10. The composition according to claim 9, wherein the plasticizing agent includes alkylbenzene groups.

11. The composition according to claim 1, wherein the additives include silica.

12. The composition according to claim 1, wherein the additive includes a petroleum based resin.

13. The composition according to claim 1, wherein the additive includes a block polymer containing styrene-butadiene groups.

14. The composition according to claim 13, wherein the block polymer is a styrene-butadiene-styrene block polymer (SBS) or a styrene-ethylene-butadiene-styrene block polymer (SEBS).

15. The composition according to claim 1, wherein the additive includes the components on a weight basis:

| COMPONENT | CONTENT (wt %) |
|---|---|
| Polymeric material based on | 15 to 20 |
| Alkylbenzene | |
| Silica | 15.5 to 20.5 |
| Ethylene propylene co-polymer (EPM) | 21.0 to 30 |
| Petroleum resin | 20 to 30 |
| Styrene-butadiene block polymer (SBS) | 11.5 to 15.5 |

16. The composition according to claim 1, wherein the ratio of oil to additive in the binder composition is in the range of 95-80 to 2 to 20.

17. The composition according to claim 1, wherein the oil is an aromatic or non-aromatic containing oil.

18. The composition according to claim 17, wherein the oil is a non-aromatic oil containing either one or a blend of paraffinic and naphthenic hydrocarbons.

19. The composition according to claim 1, wherein the composition includes a green pigment.

20. The composition according to claim 1, wherein the granular material comprises grains ranging from 0.05 mm to 5.0 mm.

21. The composition according to claim 1, wherein the amount of binder composition combined with the granular material ranges from approximately 1 to 15% of the weight of the granular material.

22. The composition according to claim 1, wherein the amount of binder composition combined with the granular material ranges from 4 to 6% of the weight of the granular material.

23. The composition according to claim 1, wherein the granular material is sand.

24. The composition according to claim 1, wherein the composition includes fibre for reinforcing and stabilizing the granular material.

25. The composition according to claim 24, wherein the fibre is in the form of discrete fibres.

26. The composition according to claim 25, wherein the fibre includes polyolefins based fibres such as but by no means limited to polyethylene, polypropylene, polyester and polyamide fibres.

27. The composition according to claim 24, wherein the fibre is straight or curled and ranges from 2 mm to 50 mm in length.

28. The composition according to claim 24, wherein the fibres are obtained from automobile tyres.

29. The composition according to claim 1, wherein the composition in addition to the granular material includes rubberised or elasticised particles.

30. The composition according to claim 29, wherein the rubberized or elasticised particles are obtained from automobile tyres.

31. The composition according to claim 1, wherein the composition includes fibre and rubberized or elasticised particles at an amount ranging from 6 to 10% by weight of the granular material.

32. A method of making a track suitable for horse racing or training, the method including the steps of:
a) mixing the granular material and binder composition of claim 1;
b) laying the mixture formed by step a) at a thickness greater than or equal to 100 mm; and
c) incorporating either one or a combination of fibre, or rubberised particles or elasticised particles into the mixture formed by step b).

33. The method according to claim 32, wherein the binder composition is mixed with the granular material at an amount ranging from 3 to 8% of the weight of the granular material.

34. The method according to claim 32, wherein the granular material is mixed with the binder composition according to step a) with the granular material at a temperature ranging from 120 to 140° C.

35. The method according to claim 32, wherein the granular material is sand having a size ranging from 0.02 to 1.5 mm.

36. The method according to claim 32, wherein the method includes evaporating excess water from the sand before carrying out step a).

37. The method according to claim 32, wherein step c) involves distributing fibre and rubberised particles over the mixture laid in step b) at an amount up to 10 kg per square metre.

38. A horse training or racing track, wherein the surface of the track comprises the particulate composition according to claim 1.
